(19) United States
(12) Patent Application Publication
(10) Pub. No.: US 2008/0080025 A1
(43) Pub. Date: Apr. 3, 2008

(54) IMAGE PROCESSING APPARATUS AND METHOD FOR MANAGING IMAGE PROCESSING APPARATUS

(76) Inventors: Thomas Sheng, Hsin-Chu Hsien (TW); Po-Sheng Shih, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/855,158

(22) Filed: Sep. 14, 2007

(30) Foreign Application Priority Data
Oct. 2, 2006 (TW) 095136567

(51) Int. Cl. H04N 1/46

(52) U.S. Cl. 358/501

(57) ABSTRACT

A method for managing an image processing apparatus is disclosed. The method includes receiving a signal of selecting a color image output mode, requesting an input of verification data, determining the validity of the verification data, and performing an image outputting procedure according to the validity of the verification data. The step of performing the image outputting procedure according to the validity of the verification data comprises outputting a color image when the verification data is determined valid and outputting a monochromatic image when the verification data is determined invalid.

### BACKGROUND OF THE INVENTION

1. Field of the Invention

The present invention relates to an image processing apparatus and a method for managing the image processing apparatus, and more particularly, to an image processing apparatus and a method for verifying if a user has authorization to print a color image.

2. Description of the Prior Art

Two main streams of printers at present are ink-jet printers and laser printers and the price of laser printers is higher than the price of ink-jet printers. Laser printers have greater print quality, faster print speed, cheaper materials, and are suitable for enterprises that have the needs for mass printings. Therefore, laser printers have become a necessary auxiliary tool for enterprises. Besides, Laser printers include monochromatic laser printers and color laser printers.

Because the price of a color laser printer is much higher than that of a monochromatic laser printer, and documents and charts are produced in bulk, instead of using the color laser printer, enterprises usually use both the monochromatic laser printer and the ink-jet printer to produce color print jobs. Such arrangement not only wastes time and space, but also is not user-friendly. Hence, more and more enterprises are willing to pay a higher price for a color laser printer to produce both the monochromatic and color print job. Even when a color laser printer is used, the cost of producing a monochromatic document is much lower than the cost of producing a color document. However, the color laser printers at present for business use are not capable of controlling the access to the use of the color printing function. Thus, the means to manage the image processing apparatus so as to prevent unnecessary prints and reduce superfluous cost of enterprises has become important.

### SUMMARY OF THE INVENTION

The claimed invention provides a method for managing an image processing apparatus. The method includes receiving a signal of selecting a color image output mode, requesting an input of verification data, determining the validity of the verification data, and performing an image outputting procedure according to the validity of the verification data. The step of performing the image outputting procedure according to the validity of the verification data includes outputting a color image when the verification data is determined valid and outputting a monochromatic image when the verification data is determined invalid. The verification data includes a user identification code and/or a user password, or the verification data indicates if a user is authorized to use the color image output mode.

The claimed invention provides an image processing apparatus. The image processing apparatus includes an input device, a display device, and a control unit. The input device has a plurality of function keys. The display device is used for displaying an operational status of the image processing apparatus. The control unit is coupled to the input device and to the display device. The control unit is used for receiving a signal of selecting a color image output mode and verification data, for determining the validity of the verification data, and for performing an image outputting procedure according to the validity of the verification data. The control unit is further used for performing the image outputting procedure to output a color image when the verification data is determined valid and for performing the image outputting procedure to output a monochromatic image when the verification data is determined invalid. The image processing apparatus is a color laser printer or a color multi-function printer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a flow chart illustrating the method for managing an image processing apparatus according to a first embodiment of the present invention.

FIG. 2 is a diagram of a flow chart illustrating the method for managing the image processing apparatus according to a second embodiment of the present invention.

FIG. 3 is a diagrammatical perspective view of the image processing apparatus according to the present invention.

FIG. 4 is a block diagram of the image processing apparatus according to a third embodiment of the present invention.

FIG. 5 is a block diagram of the image processing apparatus according to a fourth embodiment of the present invention.

### DETAILED DESCRIPTION

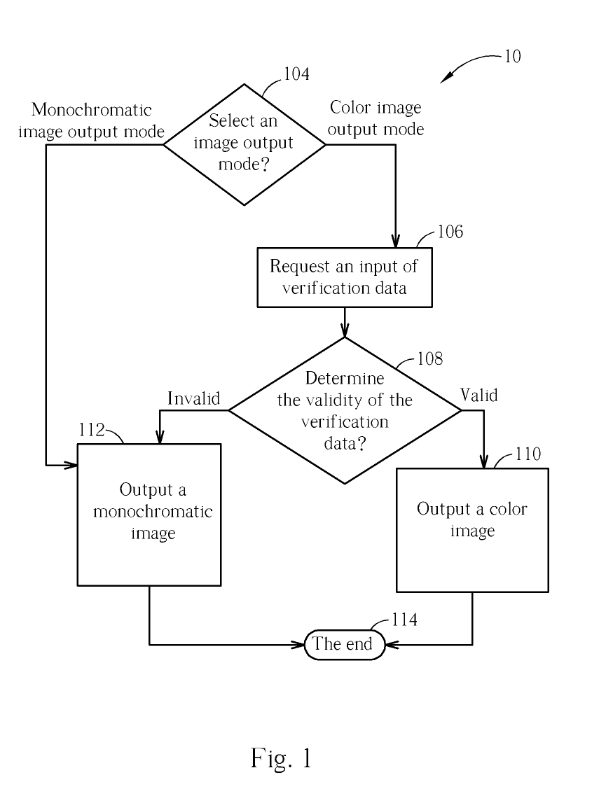

Please refer to FIG. 1. FIG. 1 is a diagram of a flow chart 10 illustrating a method for managing an image processing apparatus according to a first embodiment of the present invention. The method illustrated in the flow chart 10 includes the following steps:

Step 104: Select an image output mode. If the color image output mode is selected, that is, a signal indicating the selection of the color image output mode is received by the image processing apparatus, proceed to step 106; otherwise, proceed to step 112.

Step 106: Request an input of verification data.

Step 108: Determine the validity of the verification data. If the verification data is determined valid, proceed to step 110; otherwise, proceed to step 112.

Step 110: Perform the image outputting procedure to output a color image.

Step 112: Perform the image outputting procedure to output a monochromatic image.

Step 114: The end.

In step 104, if the signal of selecting the color image output mode is not received, the image outputting procedure is performed to output the monochromatic image (step 112). On the other hand, if the signal of selecting the color image output mode is received, the users are requested to input the verification data (step 106). In step 108, the validity of the verification data is determined. The image outputting procedure is performed to output the color image if the verification data is determined valid (step 110), and the image outputting procedure is performed to output the monochromatic image if the verification data is determined invalid (step 112).

Please note that, the image processing apparatus can be a color laser printer or a color multi-function product capable of scanning and printing. The present invention is disclosed to manage the image processing apparatus through the verification of the user input. A color image is outputted only when the users have the authorization to access the color image output mode of the image processing apparatus. In step 106, the verification data can be a user identification number, a user password, both the user identification number and the user password, or any data indicating that the user is authorized to use the color image output mode, and is not restricted to one set of data only. Furthermore, the image outputting procedure includes the step of printing or reproducing images, and is not restricted to one of them only.

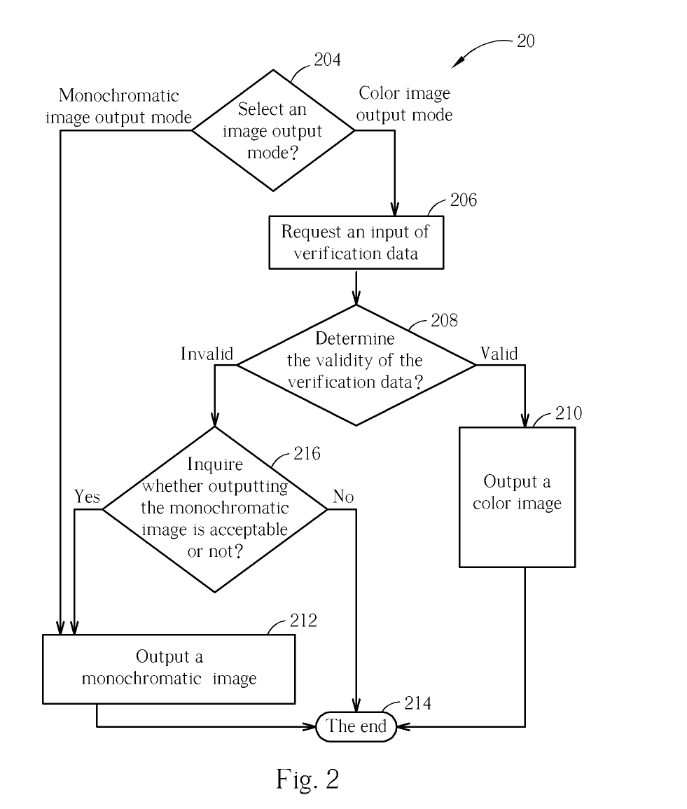

Please refer to FIG. 2. FIG. 2 is a diagram of a flow chart 20 illustrating a method for managing an image processing apparatus according to a second embodiment of the present invention. The method illustrated in the flow chart 20 includes the following steps:

Step 204: Select an image output mode. If the color image output mode is selected, that is, a signal indicating the selection of the color image output mode is received by the image processing apparatus, proceed to step 206; otherwise, proceed to step 212.

Step 206: Request an input of verification data.

Step 208: Determine the validity of the verification data. If the verification data is determined valid, proceed to step 210; otherwise, proceed to step 216.

Step 210: Perform the image outputting procedure to output a color image.

Step 216: Inquire whether outputting the monochromatic image is acceptable or not. If outputting the monochromatic image is acceptable, proceed to step 212; otherwise, proceed to step 214.

Step 212: Perform the image outputting procedure to output a monochromatic image.

Step 214: The end.

The steps 204-210 of the method according to the second embodiment are the same as the steps 104-110 of the method according to the first embodiment. The difference between the two methods is that the method illustrated in the flow chart 20 further includes a step 216. The message for inquiring whether outputting the monochromatic image is acceptable to the user is put forward before the image outputting procedure is performed to output the monochromatic image when the verification data is determined invalid. If outputting the monochromatic image is acceptable, the procedure proceeds to step 212; otherwise, end the flow.

Please note that again, the steps of the abovementioned methods illustrated in the flow charts 10 and 20 are only preferred embodiments for illustrating the present invention, the steps of the flow charts 10 and 20 are not invariable. For example, some other in-between steps can be inserted into the flow charts 10 and 20.

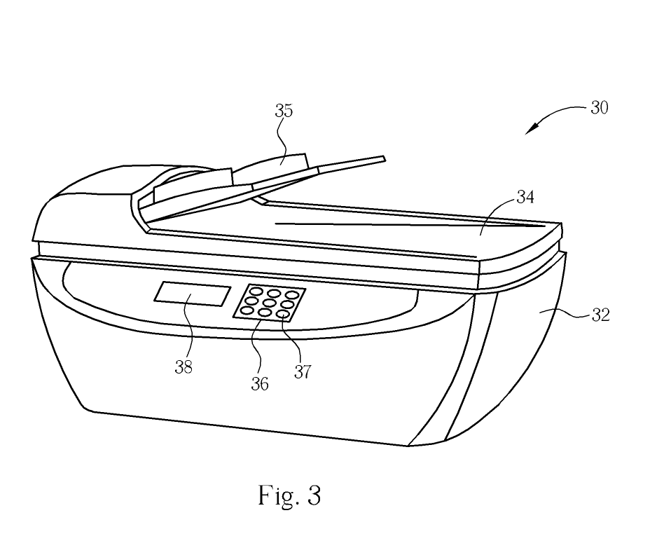

Please refer to FIG. 3. FIG. 3 is a diagrammatical perspective view of an image processing apparatus 30 according to the present invention. The image processing apparatus 30 includes a housing 32, a paper output tray 34, a paper input tray 35, an input device 36, and a display device 38. The paper input tray 35 is disposed on the housing 32 for inputting papers. The paper output tray is disposed on the housing 32 for holding paper outputs after printing. The input device 36 is disposed on the housing 32 and has a plurality of function keys 37 used for receiving the input of verification data and/or the selection of the image output modes. The input device 36, for example, could be a keypad. The input device 36 is also used for enabling the users to control operations of the image processing apparatus 30. The display device 38 is disposed on the housing 32 for displaying an operational status of the image processing apparatus 30 and the input device 36. For example, the display device 38 is used for displaying the message for requesting verification data when the image processing apparatus receives a signal of selecting a color image output mode. The display device 38 could be a LCD monitor. Please note that, the image processing apparatus 30 can be a color laser printer or a color multi-function printer, or other image processing apparatuses. Although the input device 36 and the display device 38 in FIG. 3 are disposed on the housing 32, these two devices could also be stand-alone devices detached from the image processing apparatus 30.

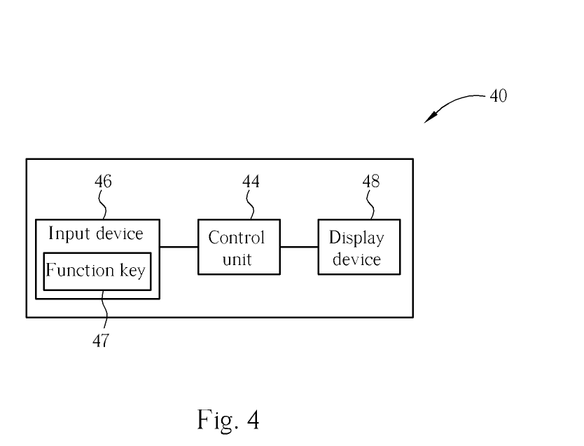

Please refer to FIG. 4 that is a block diagram of an image processing apparatus 40 according to a third embodiment of the present invention. The image processing apparatus 40 includes an input device 46, a display device 48, and a control unit 44. The input device 46 and the display device 48 are functioning the same as the input device 36 and the display device 38 shown in FIG. 3. The control unit 44 is coupled to the input device 46 and to the display device 48 for receiving a signal of selecting a color image output mode and verification data, for determining the validity of the verification data, and for performing an image outputting procedure according to the validity of the verification data. The control unit 44 is further used for outputting a color image when the verification data is determined valid, for outputting a monochromatic image when the verification data is determined invalid, for inquiring whether or not outputting the monochromatic image is acceptable, and for determining whether or not to perform the image outputting procedure to output the monochromatic image according to an indicative signal received. Please note that, the image processing apparatus 40 can be a color laser printer or a color multi-function printer, or other image processing apparatuses.

Still referring to FIG. 4, a message of “selecting an image output mode” may be displayed on the display device 48 when the users want to print data or reproduce documents. The users can select an image output mode by using the plurality of function keys 47 of the input device 46. A message of “input of verification data” may be displayed on the display device 48 after the control unit 44 receives the signal of selecting the color image output mode. The users can input data by using the plurality of function keys 47 of the input device 46. The control unit 44 will determine if the verification data is valid or not when the image processing apparatus 40 receives the verification data. The control unit 44 will output a color image when the verification data is determined valid. The control unit 44 will output a monochromatic image when the users initially select a monochromatic image output mode or when the verification data entered is determined invalid.

Please continue referring to FIG. 4. The control unit 44 determines whether or not the verification data is valid when the image processing apparatus 40 receives the verification data. A message of “is outputting the monochromatic image acceptable” may be displayed on the display device 48 when the verification data is determined invalid. The users can input data by using the plurality of function keys 47 of the input device 46. The control unit 44 will output a monochromatic image when receiving the affirmative user command to output the monochromatic image.

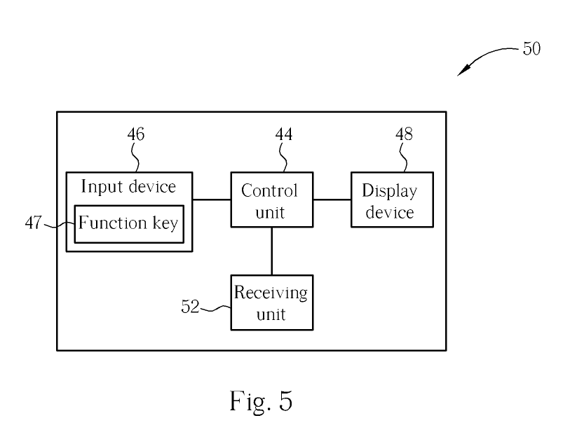

Please refer to FIG. 5. FIG. 5 is a block diagram of an image processing apparatus 50 according to a fourth embodiment of the present invention. The image processing apparatus 50 includes an input device 46, a display device 48, a control unit 44, and a receiving unit 52. The image processing apparatus 50 is similar to the image processing apparatus 40. The differences between them is that the image processing apparatus 50 further includes the receiving unit 52 coupled to the control unit 44 for receiving a signal of selecting the color image output mode from a remote host through a network. Therefore, the verification data or the signal of selecting the image output mode can be inputted by a keyboard of the remote host through the receiving unit 52 instead of by the plurality of function keys 47 of the input device 46. The users can either control the image processing apparatus 50 to perform the image outputting procedure directly or control the image processing apparatus 50 to perform the image outputting procedure by the keyboard of the remote host through the network.

The above-mentioned embodiments illustrate but do not limit the present invention. The verification data mentioned in the steps 106 and 206 includes, but is not limited to, the user identification number, the user password, or both the user identified number and the user password only. It can be any data in other types and is not restricted to one set of data only and can be expanded to a plurality of sets of data capable of indicating whether a user is authorized to use the color image output mode. The user identification number or the user password is not fixed and can be changed depending on user's demand. The image processing apparatuses 30, 40, and 50 can be a color laser printer or a color multi-function printer, and can be other image processing apparatuses.

In conclusion, the present invention provides an image processing apparatus and a method for managing the image processing apparatus. The users can command the image processing apparatus to print or reproduce color images only when the users are authorized to utilize the color image print mode or the color image copy mode. Therefore, by the implementation of such system, the cost for the consumables of printers can be controlled effectively, and the expense on the non-production materials could be reduced as well.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for managing an image processing apparatus, the method comprising:
receiving a signal of selecting a color image output mode;
requesting an input of verification data;
determining the validity of the verification data; and
performing an image outputting procedure according to the validity of the verification data.

2. The method for managing the image processing apparatus of claim 1, wherein the image outputting procedure comprises the step of printing or reproducing images.

3. The method for managing the image processing apparatus of claim 1, wherein the step of performing the image outputting procedure according to the validity of the verification data comprises outputting a color image when the verification data is determined valid.

4. The method for managing the image processing apparatus of claim 1, wherein the step of performing the image outputting procedure according to the validity of the verification data comprises outputting a monochromatic image when the verification data is determined invalid.

5. The method for managing the image processing apparatus of claim 1, wherein the step of performing the image outputting procedure according to the validity of the verification data comprises:
requesting a user input command for outputting a monochromatic image when the verification data is determined invalid; and
outputting the monochromatic image according to the user input command.

6. The method for managing the image processing apparatus of claim 1, wherein the verification data comprises one of a user identification code and a user password.

7. The method for managing the image processing apparatus of claim 1, wherein the verification data comprises a user identification code and a user password.

8. The method for managing the image processing apparatus of claim 1, wherein the verification data indicates if a user is authorized to use the color image output mode.

9. The method for managing the image processing apparatus of claim 1, wherein the step of determining the validity of the verification data comprises determining if the verification data matches one of valid data stored in a database.

10. An image processing apparatus comprising:
an input device having a plurality of function keys;
a display device for displaying an operational status of the image processing apparatus; and
a control unit, coupled to the input device and the display device, for receiving a signal of selecting a color image output mode and verification data, for determining the validity of the verification data, and for performing an image outputting procedure according to the validity of the verification data.

11. The image processing apparatus of claim 10, wherein the plurality of function keys are used for inputting the verification data.

12. The image processing apparatus of claim 10, wherein the plurality of function keys are used for selecting the color image output mode.

13. The image processing apparatus of claim 10, wherein the control unit is used for performing the image outputting procedure to output a color image when the verification data is determined valid.

14. The image processing apparatus of claim 10, wherein the control unit is used for performing the image outputting procedure to output a monochromatic image when the verification data is determined invalid.

15. The image processing apparatus of claim 10, wherein the control unit is used for requesting a user input command for outputting a monochromatic image when the verification data is determined invalid and outputting the monochromatic image according to the user input command.

16. The image processing apparatus of claim 15, wherein the display device displays the inquiry.

17. The image processing apparatus of claim 10, wherein the image processing apparatus is one of a color laser printer and a color multi-function peripheral.

18. The image processing apparatus of claim 10 further comprising a receiving unit for receiving the signal of selecting the color image output mode from a remote host through a network.
